(19) United States
(12) Patent Application Publication
(10) Pub. No.: US 2016/0165838 A1
(43) Pub. Date: Jun. 16, 2016

(54) Pet Feeding Device

(71) Applicant: Burton Chubeck, Sarasota, FL (US)

(72) Inventor: Burton Chubeck, Sarasota, FL (US)

(21) Appl. No.: 14/799,786

(22) Filed: Jul. 15, 2015

Related U.S. Application Data
(60) Provisional application No. 62/090,541, filed on Dec. 11, 2014.

(51) Int. Cl. A01K 5/01; A01K 29/00; A01K 7/00

(52) U.S. Cl. CPC A01K 5/0107; A01K 5/0114; A01K 7/00; A01K 29/00

(57) ABSTRACT

A pet feeding device is provided. The pet feeding device includes a tapered rectangular housing having a hollow interior volume and a raised upper surface. A pair of opposing circular cutouts is disposed on the raised upper surface of the rectangular housing. The cutouts are adapted to receive a pair of bowls therein. An elongated handle is integrally attached to the upper surface. The handle includes a pair of arms extending vertically to an arched handle portion. The elongated handle allows a user to lift the housing so as to dispose the housing on a tabletop or countertop for filling or emptying the bowls.

### CROSS REFERENCE TO RELATED APPLICATION

This application claims the benefit of U.S. Provisional Application No. 62/090,541 filed on Dec. 11, 2014. The above identified patent application is herein incorporated by reference in its entirety to provide continuity of disclosure.

### FIELD OF THE INVENTION

The present invention generally relates to a pet feeding device. More specifically, the present invention relates to a pet feeding device including a tapered rectangular housing having an elongated handle integrally attached to the upper surface of the housing. The handle includes a pair of arms extending vertically to an arched handle portion.

### BACKGROUND OF THE INVENTION

When pet owners feed their pets, they normally place the food in a bowl and then place the bowl on the floor to allow the pet access to the food. The pet owner may have to refill the pet's bowl multiple times per day, which can be inconvenient and time consuming. Further, the pet owner often needs to clean the bowl between uses so as to eliminate any remaining food waste and sanitize the bowl.

Many individuals have a difficult time bending over to fill or empty a pet's food bowl. This is particularly true for handicapped or elderly pet owners. As a result, the pet owner risks injury by repeatedly bending over to fill and clean pet food bowls, and the pet owner may not feed the pet at the appropriate times due to the difficulty of cleaning and filling the food bowls. Thus, a device that allows a pet owner to lift a pet bowl without bending over is desired.

Devices have been disclosed in the prior art that relate to devices for raising and lowering food or water bowls. These include devices that have been patented and published in patent application publications. U.S. Published Patent Application Number 2013/0019808, U.S. Pat. No. 7,318,391, U.S. Pat. No. 5,787,839, and U.S. Pat. No. 3,653,362 relate to pet food bowls that raise and lower bowls to a desired height. Other devices provide elevated dog bowls with a handle, such as U.S. Design Pat. No. D451,648.

These prior art devices have several known drawbacks. Pet feeding devices in the prior art fail to disclose an elongated handle integrally attached to the upper surface of a rectangular housing, wherein the handle includes a pair of arms extending vertically to an arched handle portion. Further, the prior art pet feeding devices do not provide a tapered housing with cutouts for receiving food bowls therein.

In light of the devices disclosed in the prior art, it is submitted that the present invention substantially diverges in design elements from the prior art and consequently it is clear that there is a need in the art for an improvement to existing pet feeding devices. In this regard the instant invention substantially fulfills these needs.

### SUMMARY OF THE INVENTION

In view of the foregoing disadvantages inherent in the known types of pet feeding devices now present in the prior art, the present invention provides a new and improved pet feeding device wherein the same can be utilized for providing convenience for the user when filling or emptying pet food bowls.

It is therefore an object of the present invention to provide a new and improved pet feeding device that has all of the advantages of the prior art and none of the disadvantages.

It is another object of the present invention to provide a pet feeding device including a tapered rectangular housing having a hollow interior volume and a raised upper surface, wherein the housing tapers from the bottom to the upper surface.

Another object of the present invention is to provide a pet feeding device including a pair of opposing circular cutouts disposed on the raised upper surface of the rectangular housing, wherein the cutouts are adapted to receive a pair of bowls therein.

A further object of the present invention is to provide a pet feeding device including an elongated handle integrally attached to the upper surface. The handle comprises a pair of arms extending vertically to an arched handle portion. The handle is disposed midway between the cutouts on the upper surface. The arched handle portion is U-shaped so as to allow a user to grasp the device.

Yet another object of the present invention is to provide a pet feeding device having a handle with a pair of arms that are of sufficient length so that a user does not have to bend over in order to grasp the handle.

Still yet another object of the present invention is to provide a pet feeding device including a pair of removable bowls disposed within the circular cutouts on the raised upper surface of the housing.

Another object of the present invention is to provide a pet feeding device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the pet feeding device according to one embodiment of the present invention.

FIG. 2 shows a close-up view of the housing of the pet feeding device according to one embodiment of the present invention.

FIG. 3 shows a side view of the elongated handle of the pet feeding device according to one embodiment of the present invention.

### DETAILED DESCRIPTION OF THE INVENTION

Reference is made herein to the attached drawings. Like reference numerals are used throughout the drawings to depict like or similar elements of the pet feeding device. For the purposes of presenting a brief and clear description of the present invention, the preferred embodiment will be discussed as used for filling or emptying pet food bowls. The figures are intended for representative purposes only and should not be considered to be limiting in any respect.

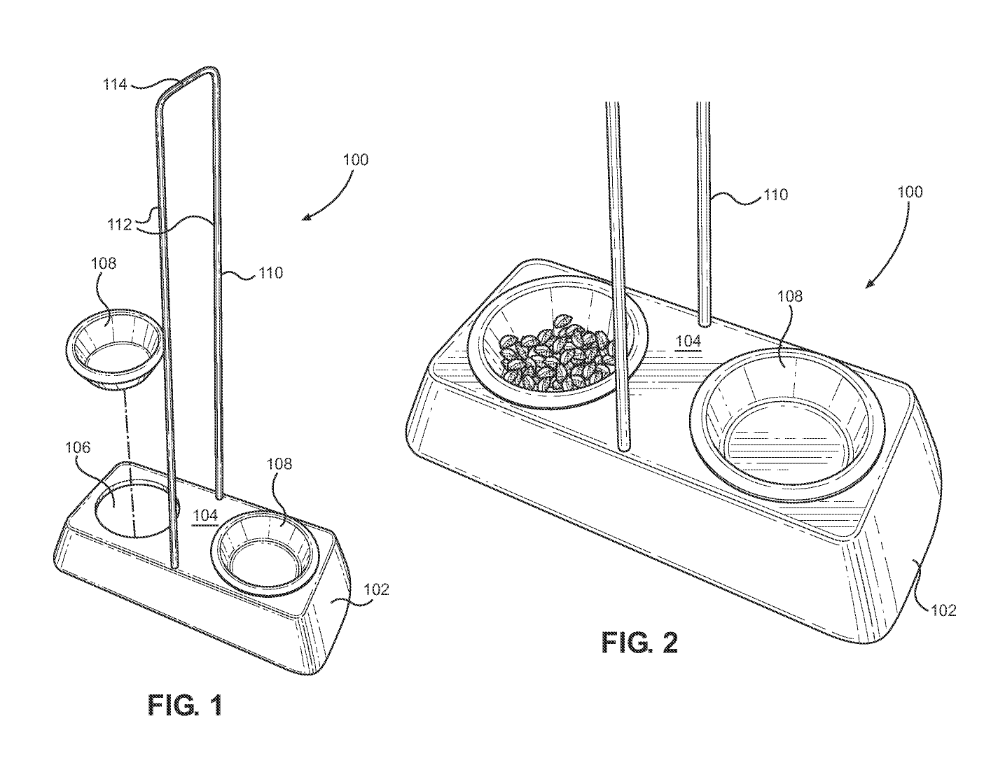

Referring now to FIGS. 1 and 2, there are shown perspective views of the pet feeding device according to one embodiment of the present invention. The pet feeding device 100 includes a rectangular housing 102 having a hollow interior volume. The housing 102 extends upwardly from a base portion to a raised upper surface 104. The housing 12 preferably tapers from the base portion towards the raised upper surface 104. The housing 102 is formed from a lightweight and durable material by injection molding.

The housing 102 further includes a pair of opposing circular cutouts 106 disposed on the raised upper surface 104 of the housing. The cutouts 106 are preferably bowl-shaped openings formed in the upper surface 104 having an outer sidewall with an annular edge. The cutouts 106 are adapted to receive a pair of bowls 108 within the interior volume of the housing 102.

An elongated handle 110 is integrally attached to the upper surface 104 of the housing 102. The handle 110 comprises a pair of vertically extending arms 112 that terminate at an arched handle portion 114. The handle portion 114 is an ergonomic grip that connects each arm 112. The handle 110 is disposed midway between the cutouts 106 on the upper surface 104. In the illustrated embodiment, the arched handle 114 portion is U-shaped. The arms 112 are preferably sufficiently long so that a user does not need to bend over in order to grasp the handle 110. Preferably, the arms are between two and four feet in length. In alternate embodiments, the arms 112 may be telescopic such that a user can adjust the height of the handle 110 to a desired length.

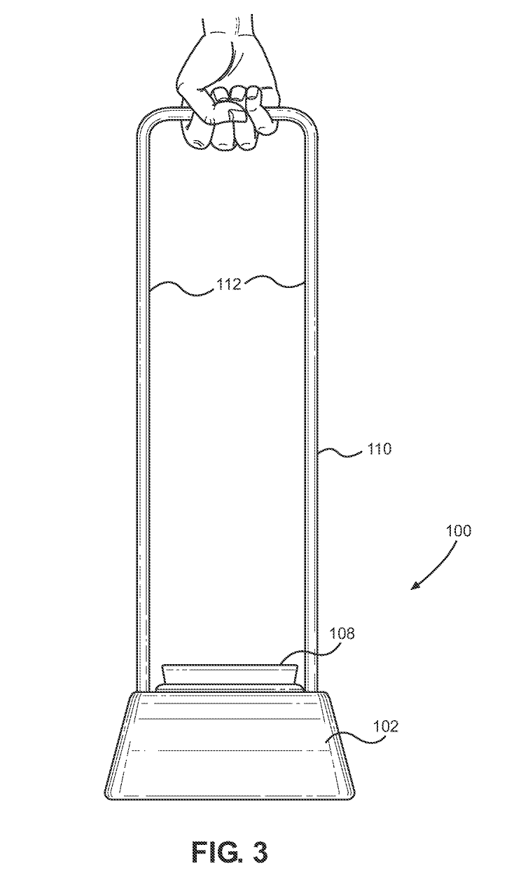

Referring now to FIG. 3, there is shown a side view of the elongated handle of the pet feeding device according to one embodiment of the present invention. The pet feeding device 100 comprises a rectangular housing 102 adapted to hold one or more food bowls 108 therein. The pet feeding device 100 may further include removable bowls 108 disposed within the circular cutouts 106 on the raised upper surface 104. The removable bowls 108 are preferably fabricated from stainless steel. Alternatively, the housing 102 may include one or more food bowls 108 integrally formed therein. The food bowls 108 are adapted to hold any type of pet food as desired by the user. The housing 102 further includes a rigid, elongated handle 110 that extend vertically upward from the housing 102. The handle allows a user to lift the food bowls into an elevated position so that the user can empty, clean, or fill the pet bowl without having to bend over.

In operation, a user can grasp the handle 110 of the pet feeding device 100. The device 100 can be lifted via the handle to gain access to the bowls 108. In this way, a user does not have to bend over to fill or clean the bowls 108 disposed on the rectangular housing 102. The bowls 108 are removable from the housing 108 and can be cleaned or filled with food. Once cleaned and filled, the bowls 108 are placed in the cutouts 106 and the housing 102 can be placed back on the floor for the pet.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A pet feeding device, comprising:
a housing having a hollow interior volume and a raised upper surface;
a pair of opposing cutouts disposed on the raised upper surface of the housing, wherein the cutouts are adapted to receive a pair of bowls within the interior volume of the housing;
an elongated handle integrally attached to the upper surface, wherein the handle comprises a pair of arms extending vertically to an arched handle portion.

2) The pet feeding device of claim 1, wherein the handle is disposed between the pair of cutouts on the upper surface.

3) The pet feeding device of claim 1, wherein the arched handle portion is U-shaped.

4) The pet feeding device of claim 1, further comprising removable bowls disposed within the pair of cutouts on the raised upper surface.
